(19) United States
(12) Patent Application Publication
(10) Pub. No.: US 2007/0025576 A1
(43) Pub. Date: Feb. 1, 2007

(54) Telescope style microphone with dual effects for enhancing physical acoutsic volume and acquiring uni-directional acoustic source

(76) Inventor: Yung Chuan Wen, Xin-Dian City (TW)

Correspondence Address: TROXELL LAW OFFICE PLLC;SUITE 1404, 5205 LEESBURG PIKE, FALLS CHURCH, VA, 22041, US

(21) Appl. No.: 11/346,333

(22) Filed: Feb. 3, 2006

(30) Foreign Application Priority Data
Jul. 26, 2005 (TW) 094212617

(51) Int. Cl. H04R 9/08

(52) U.S. Cl. 381/361

(57) ABSTRACT

The present invention relates to a microphone with dual effects for enhancing the physical acoustic volume and for acquiring uni-directional acoustic source. The microphone applies the viewfinder theory of the telescope. The sound source at a designated direction is past from the front end of a hollow tube through the tube such that the sound generates resonance and focusing effects when passing through the tube. The microphone provided at the end of the tube is allowed to increase the volume acquired without using a passive amplifying circuit. A high ratio of sound at the designated direction can also be acquired.

### CROSS-REFERENCE TO RELATED APPLICATIONS

Not Applicable

### STATEMENT REGARDING FEDERALLY SPONSORED RESEARCH OR DEVELOPMENT

Not Applicable

### DESCRIPTION

1. Field of the Invention

The present invention relates to a microphone; more particularly, the present invention relates to a microphone that applies the viewfinder theory of the telescope. The acoustic source at a designated direction is past from the front end of a hollow tube through the tube such that the sound generates resonance and focusing effects when passing through the tube. The microphone provided at the end of the tube is allowed to increase the acoustic volume acquired without using passive amplifying circuit. A high ratio of sound at the designated direction can also be acquired.

2. Background of the Invention

Generally, it is desired to have a quality directive microphone at occasions such as broadcasting, recording, media interview, telephone communication and voice recognition, etc., such that resonance feedback sound, and cross-talk can be reduced or eliminated, or such that a farther and smaller area of directive source is needed.

The present inventor has acquired and tested many so-called uni-directional microphones on the market and found the following disadvantages:
1. Bad directivity;
2. Bad acoustic quality;
3. Acoustic volume is significantly reduced and passive amplifying circuit is required to compensate for the lost sound;
4. For those products with better directivity, the structure and attached circuitries are complicated and expensive and thus are hard to become universal.

In order to overcome the above-mentioned drawbacks of the conventional commercial products, “a telescope style microphone with dual effects for enhancing physical acoustic volume and acquiring uni-directional acoustic source” is invented.

### SUMMARY OF THE INVENTION

The present invention relates to a telescope style microphone with dual effects for enhancing physical acoustic volume and acquiring uni-directional acoustic source. It applies the viewfinder theory of the telescope. The sound source at designated direction is past from the front end of a hollow tube through the tube such that the sound generates resonance and focusing effects when passing through the tube. The microphone provided at the end of the tube is allowed to increase the acoustic volume acquired without using a passive amplifying circuit. A high ratio of sound at the designated direction can also be acquired.

In accordance with the microphone of the present invention, the enhancement of the physical acoustic volume, the level of the frequency, and the depth and scope of the acquiring acoustic source are subject to the length as well as the radius of the hollow tube. Therefore, the length and the radius of the hollow tub can be implemented as fixed or adjustable. The inner wall of the hollow tube in accordance with the present invention has a rough surface and is implemented with firearm whirl rifling; as a result, the resonance effect generated when the sound is traveling inside the tube can be avoided. The present invention is thus a microphone with better sound quality, increased effect and good directivity.

### BRIEF DESCRIPTION OF THE DRAWINGS

The foregoing aspects, as well as many of the attendant advantages and features of this invention will become more apparent by reference to the following detailed description, when taken in conjunction with the accompanying drawings, wherein:

FIG. 1 is a cross-sectional view in accordance with the present invention;

FIG. 2 is a cross-sectional view of an embodiment wherein the inner wall of the hollow tube has a rough surface and is implemented with firearm whirl rifling;

FIG. 3 is a cross-sectional view of another embodiment in accordance with the present invention;

FIG. 4 is a cross-sectional view of another embodiment in accordance with the present invention.

### DETAILED DESCRIPTION OF THE EMBODIMENTS

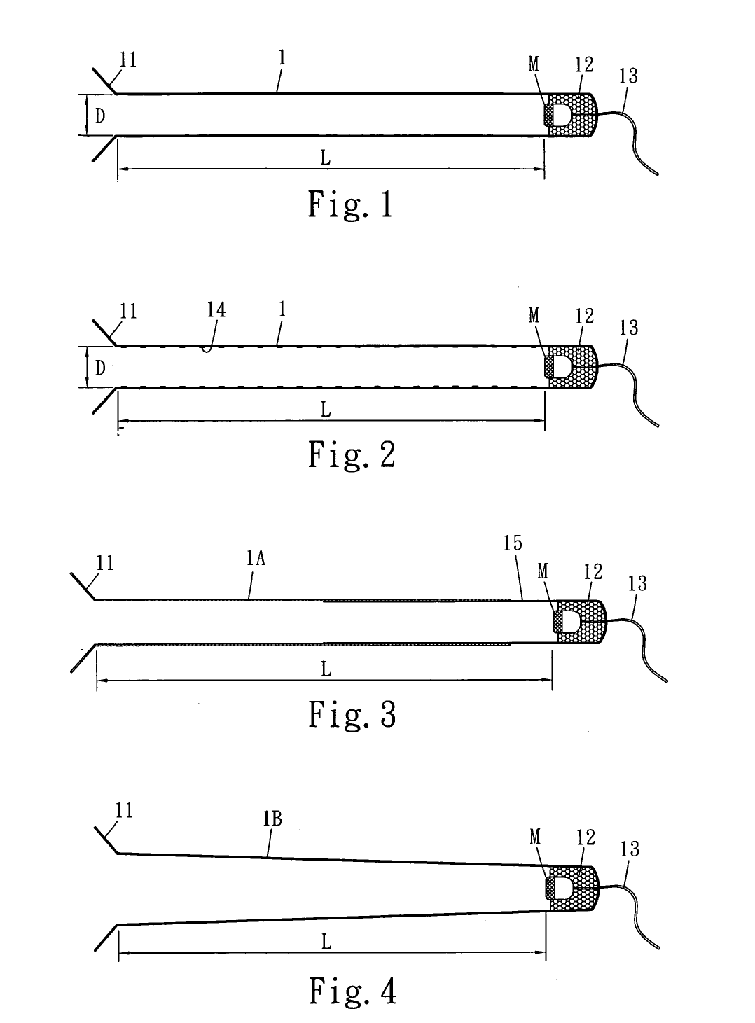

Refer to FIG. 1. The telescope style microphone with dual effects for enhancing acoustic volume and acquiring uni-directional directive acoustic source of the present invention applies the viewfinder theory of the telescope. The microphone mainly includes a hollow tube (1) with a horn-shaped opening (11) at the front end. The microphone (M) is disposed at the bottom of a sealed end of the hollow tube (1). The place where the microphone (M) is affixed is provided with a soft shock-resistant gasket (12) and a microphone (M) feeder (13).

The above-mentioned hollow tube (1) can designate a direction for acoustic source. The sound is led through the hollow tube (1) from the horn-shaped opening (11) at the front end of the hollow tube (1). Because the sound generates resonance and focusing effects when traveling in the tube, the microphone (M) disposed at the bottom of the sealed end of the hollow tube (1) has the following effects:
1. The volume is enhanced at least 10˜20 DB, which is better than the conventional configuration (such as the case when the microphone is disposed at the front or exposed) with the same model;
2. The directivity effect is enhanced at least 20 DB in the environment without acoustic reflection.

In accordance with the microphone of the present invention, the enhancement of the physical acoustic volume (not the enhancement of electrically amplified circuitry), the level of frequency acquired, and the depth, scope, and proportion of the directivity are subject to the length (L) and radius (D) of the hollow tube (1). Refer to the reference numbers in the drawings. The description is as follows:
1. The depth of the directivity of the sound acquired is directly proportional to the length of the hollow tube.
2. The width of the scope of the sound acquired is directionally proportional to the radius of the hollow tube and the horn-shaped opening at the front end.
3. The level of frequency of the sound acquired is inversely proportional to the radius; the larger the radius, the lower the frequency acquired; the lower the radius; the higher the frequency acquired.
4. The physical acoustic enhancement of the microphone is directly proportional to the radius of the hollow tube and the horn-shaped opening at the front end. When effectively configured, the microphone can enhance the acoustic volume to above 20 DB.

The length and radius of the hollow tube (1) in accordance with the present invention can vary as desired; for example, FIG. 1 shows a fixed-style hollow tube (1), while FIG. 3 shows an adjustable hollow tube (1A). Additionally, FIG. 4 shows a hollow tube (1B) with extendable radius.

As the sound travels inside the hollow tube (1), resonance can be generated due to the reflection noise of the inner wall. Refer to FIG. 2. The inner wall of the hollow tube (1), (1A), (1B) of the present invention can be a rough surface. For example, firearm while rifling (14) can be implemented to effectively reduce or eliminate the resonance effect. However, sometimes a little resonance is needed to have better acoustic effect.

The inner wall of the above hollow tube (1), (1A), (1B) can be implemented as rough surface; however, it is not limited to the firearm whirl rifling 14. Any other rough patterns, engravings, protrusions can all be implemented to provide the same effect.

As shown in FIG. 3, the above adjustable hollow tube (1B) can be implemented using a tube assembly, which includes an additional hollow tube (15).

The microphone portion of the present invention can adopt any forms of microphone (M). The firearm whirl rifling (14) can also be used for adjustment purpose.

The characteristics and advantages of the telescope style microphone with due effects for enhancing physical acoustic volume and acquiring uni-directional acoustic source in accordance with the present invention are described below:
1. The enhancement of the physical acoustic volume is above 10˜20 DB (not including the enhancement obtained from using electrically amplified circuit, such as the optical enhancement of the microphone). The better the enhancement of the physical acoustic volume, the more the effect gained by using the microphone on the product.
For example:
a) The multitude and magnitude of the electronically amplified circuit is reduced; thus, the noise, cross-talk, disturbance generated by the amplifying circuit can be reduced or eliminated.
b) The distance between the microphone and the acoustic source (or a person's mouth) can be increased.
2. The acquiring ratio of the microphone is more effective (it can reach above 20 DB in an environment without reflection). The uni-directive ratio is higher and can be used in occasions such as broadcasting, amplifying, recording, media interview, telephone communication, voice recognition, etc. As a result, the resonance effect can be reduced or eliminated, or the acoustic source can be acquired in farther distance and much purer within a particular scope.

The present invention has already been prepared with actual implementation and applied to product. Should the examination department would like to examine the product, it can be filed upon receiving the notification for examination.

What is claimed is:

1. A telescope style microphone device with dual effects for enhancing physical acoustic volume and acquiring uni-directional acoustic source, said microphone applying a viewfinder theory of a telescope so as to acquire a higher ratio of a directive acoustic source and to greatly enhance said physical acoustic volume, said microphone comprising: a hollow tube (1), having a horn-shaped opening (11) at a front end, said microphone (M) is disposed at a bottom of a sealed end of said hollow tube (1), a soft shock-resistant gasket (12) and a microphone (M) feeder (13) provided to affix said microphone (M) such that an acoustic source at a designated direction can be led to said tube from said opening at said front end, when sound traveling inside said tube, resonance and focusing effects are generated, thereby said microphone (M) at said bottom of said tube enhancing and acquiring a high directivity of an acoustic signal.

2. The microphone device according to claim 1, wherein a radius and length of said hollow tube can be fixed or adjustable depending on the need, the larger the radius, the lower the acquired frequency; the longer the length, the farther the acquired distance of the acoustic source, and vice versa.

3. The microphone device of claim 1, wherein said hollow tube can be implemented as an adjustable hollow tube or a hollow tube with an extendable inner radius.

4. The microphone device of claim 2, wherein an inner wall of said hollow tube can be a rough surface, such as a firearm whirl rifling, a rough pattern, an engraving, a protrusion, such that when sound is traveling inside said tube, resonance effect can be effectively reduced or eliminated
